(19) United States
(12) Patent Application Publication
(10) Pub. No.: US 2001/0051941 A1
(43) Pub. Date: Dec. 13, 2001

(54) Searching method of block sorting lossless compressed data, and encoding method suitable for searching data in block sorting lossless compressed data

(76) Inventor: Motonobu Tonomura, Kodaira (JP)

Correspondence Address: Mattingly, Stanger & Malur, P.C., 104 East Hume Avenue, Alexandria, VA, 22301, US

(21) Appl. No.: 09/875,161

(22) Filed: Jun. 7, 2001

(30) Foreign Application Priority Data
Jun. 13, 2000 (JP) 2000-182320

(51) Int. Cl. G06F 17/30

(52) U.S. Cl. 707/3; 707/6; 707/101

(57) ABSTRACT

The present invention provides a high speed searching method by searching by decoding only necessary data compressed and encoded by the block sorting lossless compression method, without decoding all of the encoded data.

The pairs of current sorting position number and previous sorting position number will be determined for the BW transformed rows and rows sorted with the lexicographic order in the data compressed by the block sorting lossless compression method. The data will be decoded based on the pairs while matching data with the searching character string. Only data required for the search will be decoded. The pairs of current sorting position number and previous sorting position number in the block sorting lossless compression method will be directly encoded.

### BACKGROUND OF THE INVENTION

1. Field of the Invention

The present invention relates to a searching method of block sort lossless compressed data, and a searching method of block sort lossless compressed data, which allows a high speed search by decoding only necessary data without decoding entirely encoded data, by exploiting the nature of block sorting lossless compression method for data compressed by the block sort compression method.

2. Description of the Prior Art

Information processing devices such as computers have been familiar to everyone and the opportunity of processing digital data in the daily life have been increasingly often. A technology that may encode and compress data for storage, and decode and expand thus compressed encoded data when necessary for actual use is widely noticed. The term “encoding” can be defined that it indicates a conversion from an original coding system to another coding system, and the term “decoding” indicates a reversal conversion, that restores the original coding system from the encoded coding. The term “compression” can be defined as a way for storing the original data in a storage space of less capacity, while the term “expansion” as a way to extract the original data from the compressed data into a storage area of the data capacity prior to compression.

The data compression/expansion techniques are routinely used since the personal computer or PC became popular. A data compression and decompression algorithm proposed by Lempel and Ziv in 1977, also known as the LZ compression method, is a typical example that is still widely used today. Other compression algorithms having a compression rate equal to or higher than the Lempel-Ziv method have been recently developed and one candidate, which is called the “block sorting method” has become theoretically a matter of concern these days due to its high compression ratio (c.f., Michelle Effros, Universal Lossless Source Coding with the Burrows Wheeler Transform, IEEE Proc. of DCC '99, pp. 178-187, 1999).

This compression scheme, called block sorting compression, may operate such that it creates, at first, an array of cyclic shift rows (or a rotating shift array) for the entire source text data, then it sorts all cyclic shift rows in the array with a lexicographic ordering to rearrange the rows in the array and it picks up a row therefrom to encode. For example, Burrows and Wheeler, the researchers who proposed this scheme (A block-sorting lossless data compression algorithm, SRC Research Report, 124 May 1994) choose the very last row for encoding.

The block-sorting compression method can obtain an evaluation result of compression ratio almost similar to the Lempel-Ziv method, however the final achievement of the compression ratio by block sorting stays still in the step of theoretical consideration and is not well considered as a practical method.

There are also needs of high-speed search of information, in addition to the compression of information. When the high-speed search is put at a priority level, some redundant information required for searching needs to be included into the data, resulting sometimes in that an increase of the total amount of data, rather than the compression of the amount of data.

When the amount of data to be processed becomes extremely large, causing the shortage of the storage space for storing all of the data, the data needs to be compressed for storage. This may result in a situation in which almost all of data is compressed and not used. In such a situation, a technology that may pick up a small fragment of required data from a vast plane of compressed data. Searching by expanding and decoding every compressed data is not a practical solution. A method of searching the desired data without expanding the compressed coded data is needed.

In practice, when comparing the compressed codes with a searching pattern for the data compressed by the existing Lempel-Ziv compression scheme, the searching pattern may match with the data before and after the exact targeted compressed data contents, or the compressed coded string of the pattern to be searched may not be uniquely identified so that there may be several candidates of the matching pattern. This prevents the direct search of the compressed code. Since the block sorting compression algorithm can be considered to be in the stage of evaluation and the searching method of block sorting compression data has not been well developed.

### SUMMARY OF THE INVENTION

The present invention has been made in view of the above circumstances, and it is an object to overcome the above problems and to provide a searching method for searching data from within block sorting compressed data, which allows a high speed search by searching by successively decoding a small fragment of data required therefrom, without decoding every encoded data, by applying the nature of the block sorting compression algorithm to the data compressed by the block sorting compression algorithm.

The present invention also provides an encoding scheme of block sorting lossless compression suitable for the searching.

The block sorting compression method is such that it creates an array of cyclic shifting rows for the entire text data, and then rearranges all of cyclic shift rows by sorting with lexicographic ordering. Then, if there may be a pattern to be searched for in plural positions, the pattern to be searched will have the characteristics that it may begin with the top of a row in the array, and the pattern to be searched in a plurality of positions in a consecutive series of rows in the array may appears as a block. In addition, in the decoding theory of block sorting compression data, the position of the decompressed and decoded text string in the very last row will be sorted with a lexicographic order to realign. At that point the current sorting position number will be mated with its previous sorting position number to specify the sorting position number of the original text string to decode sequentially the data from the beginning of the text by following these mated pairs.

Therefore, the present invention may provide a searching means of an improved efficiency by exploiting the nature of the block sorting compression data. More specifically, at first, the pair of the starting first and second characters of the searching pattern will be corresponded to a pair of current sorting position number and previous sorting position number. The pair corresponding to these characters may be sorted by the lexicographical order and appear as blocks so that the candidates can be narrowed. Then the pair of second and third characters of the search pattern will be corresponded to the pair of current sorting position number and previous sorting position number for the one narrowed in the previous step and this step will be repeated thereafter. If the length of the searching pattern is n, a sequential step will terminate when the pair of n-1st and nth characters of the searching pattern will be mated with the pair of current sorting position number and previous sorting position number.

As a result, there will be only the searching pattern detected at a plurality of positions, while at the same time the searching pattern included in the original data string will be detected.

When the number of appearance of the characters in the original text string is known, then the pairs of current sorting position number and previous sorting position number can be sequentially determined, so that the original text string is not needed to be entirely decoded for the matching, rather only the fragments required for matching with the searching pattern will be decoded to compare. The so-called ambiguous search can be implemented by decoding where the match can be occurred according to the procedure as have been described above.

For matching a searching pattern, the search can begin with the character that appears the least in number in the original text string to speed up the search as well as to improve the efficiency of search.

In the block sorting compression encoding, the encoding will be processed in two steps. In the first step, the original text string will be encoded in response to the length of consecutively appearing characters, as a usual idea. However, in the searching method as have been described above, the first decoding step may exist independently of the procedure for determining the pair of current sorting position number and previous sorting position number, in such a way that the efficiency may be further improved.

Therefore, in the block sorting compression encoding method, instead of compression encoding the character string of the very last row in the array, the pair of current sorting position number and previous sorting position number will be directly compressed and encoded so as to further improve the efficiency of decoding and searching. Since the pair of current sorting position number and previous sorting position number corresponds to the character string of the very last row in the array one by one, the achievement of the compression ratio at the approximately same level can be estimated. The encoding scheme of the block sorting compression encoding method may provide a compression encoding method suitable for searching.

### BRIEF DESCRIPTION OF THE DRAWINGS

FIG. 1 is a schematic block diagram of searching method of block sorting compressed data in accordance with the present invention;

FIG. 2 is a schematic block diagram of the compression encoding process by the block sorting compression encoding method;

FIG. 3 is a schematic block diagram of the block sorting compression encoding method by means of specific data;

FIG. 4 is a schematic block diagram of decompression and decoding process by the block sorting compression encoding method;

FIG. 5 is a schematic block diagram of decompression and decoding process of the block sorting compression encoding method by means of specific data;

FIG. 6 is a schematic block diagram of searching process of a method for searching compressed encoded data by the block sorting compression encoding method in accordance with the present invention;

FIG. 7 is a schematic block diagram of ambiguous searching process of a method for searching compressed encoded data by the block sorting compression encoding method in accordance with the present invention;

FIG. 8 is a schematic block diagram of decoding and searching process in response to the number of appearances of the original text string;

FIG. 9 is a schematic block diagram of compression encoding compensated for by the block sorting compression encoding method in accordance with the present invention; and

FIG. 10 is a schematic block diagram of compressed encoded data.

### DETAILED DESCRIPTION OF THE PREFERRED EMBODIMENTS

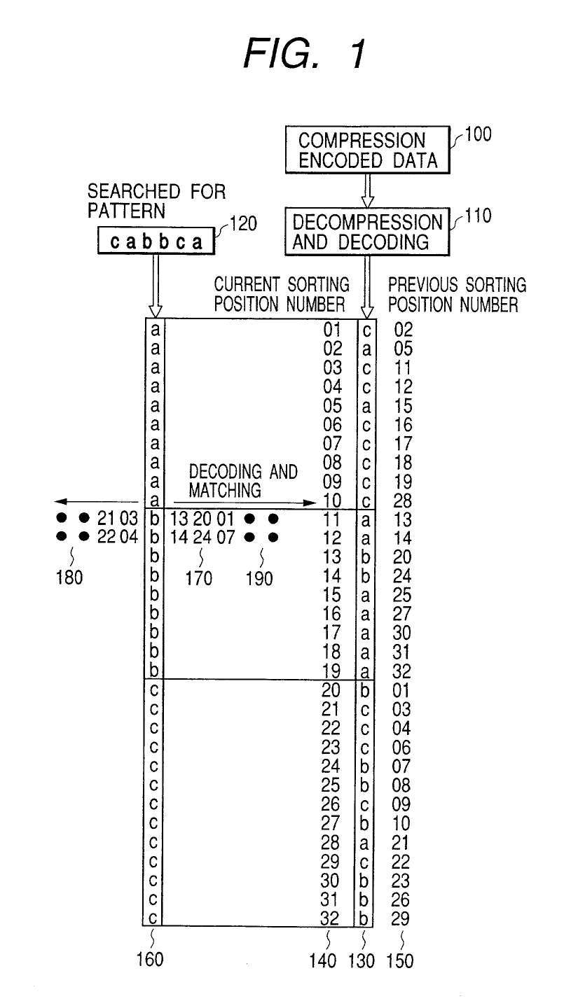

A detailed description of some preferred embodiments embodying the present invention will now be given referring to the accompanying drawings, specifically to FIG. 1 and FIG. 11.

[Block sorting compression encoding method]

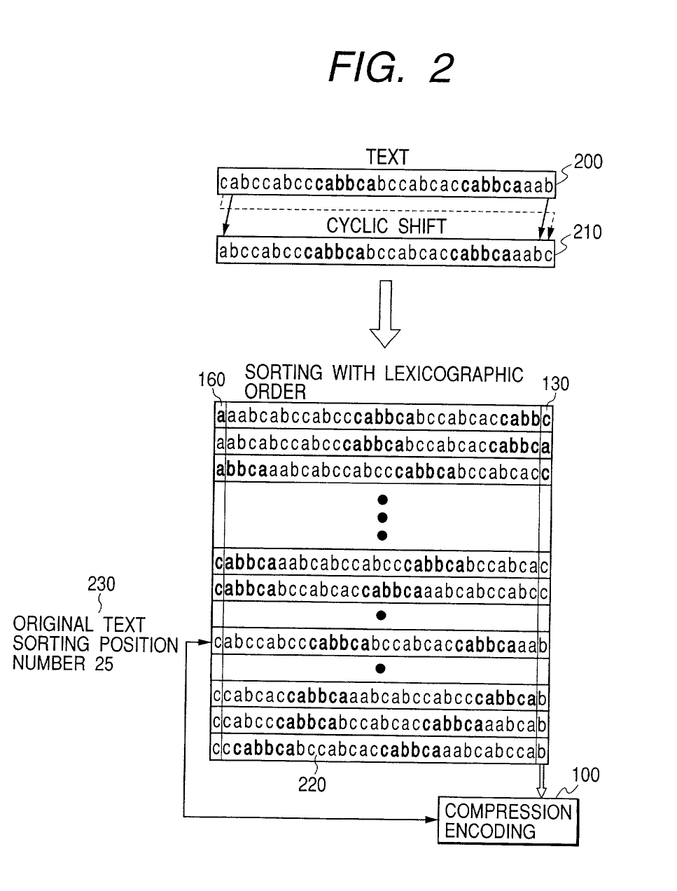

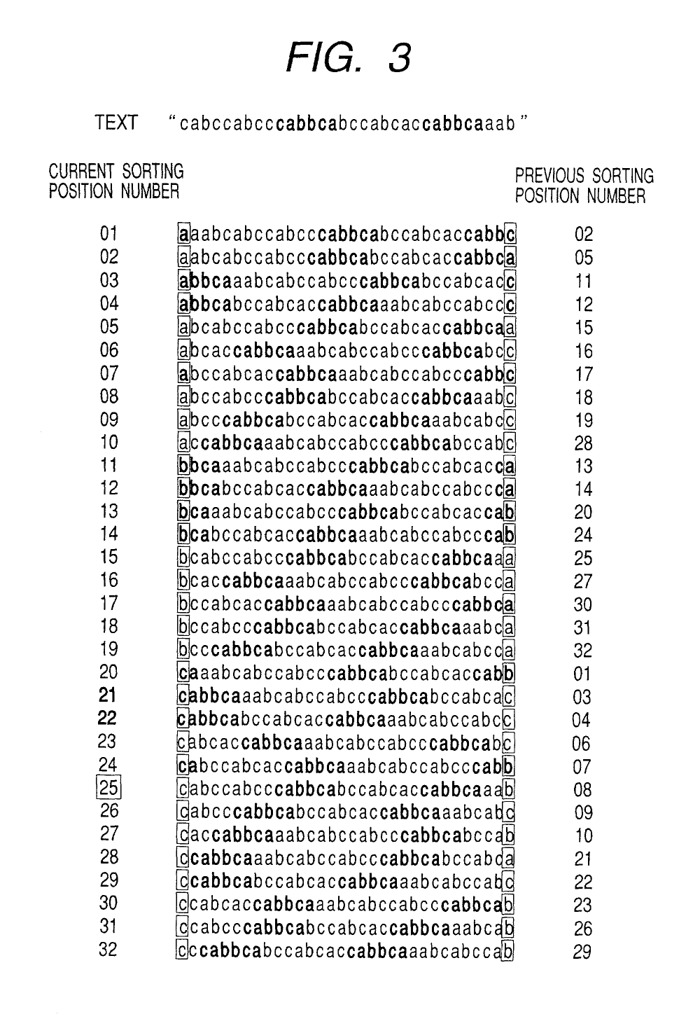

Now referring to FIG. 2 and FIG. 3 the original block sorting compression encoding method will be described prior to describing in greater details the block sorting compression encoding method in accordance with the present invention.

FIG. 2 shows a schematic block diagram of the compression encoding process by the block sorting compression encoding method, and FIG. 3 shows a schematic block diagram of the block sorting compression encoding method by means of specific data.

In the following description of the embodiments in accordance with the present invention, the original text 200 used for the compression and encoding will be always comprised of 32 characters as follows:

“cabccabcccabbcabccabcaccabbcaaab”

The fundamental algorithm of compression and encoding according to the block sorting compression encoding method will be as follows:

[Compression Step 1]

The original text 200 as have been cited above will be cyclically shifted to define a series of cyclic shift rows 210. The cyclic shift may be defined as a shift that rotates the original string in left or right hand direction by one character, and in the example shown in FIG. 2, the original text 200 have been shifted in left hand direction by one character such that the leading character “c” that run over is attached to the end of the string.

In this example of the original text 200, which is composed of 32 characters, there will be 32 cyclic shift rows 210.

[Compression Step 2]

Another array 220 will be generated by sorting the cyclic shift rows generated in the previous compression step 1 with the lexicographic order.

[Compression Step 3]

The last row 130 of the array 220 will be picked up to perform the compression encoding thereon. The transform of the original text string 200 to the last row 130 through the procedure as described above is referred to as the Burrows-Wheeler transform, or BW transform, or BWT after the name of researchers. In practice, any row in the array 220 can be picked up. In the original paper according to BW, the last row is used.

The position number 230 of the original text “25” in the array 220 will also be compressed.

It is known that the original text 200 and the BW Transform string will have the same length, however the same character tends to appear successively in the BWT string. For example, the consecutive length of character string may be encoded to achieve a higher compression ratio. There may be other ways to encode a BWT character string, and the manner as have been described above is not necessarily the sole solution.

The block sorting compression encoding method can obtain data for encoding, based on the array 220 sorted with the lexicographic order. This method is interested because a compression of higher efficiency may or may not be achieved when compared with the direct compression of the original text 200.

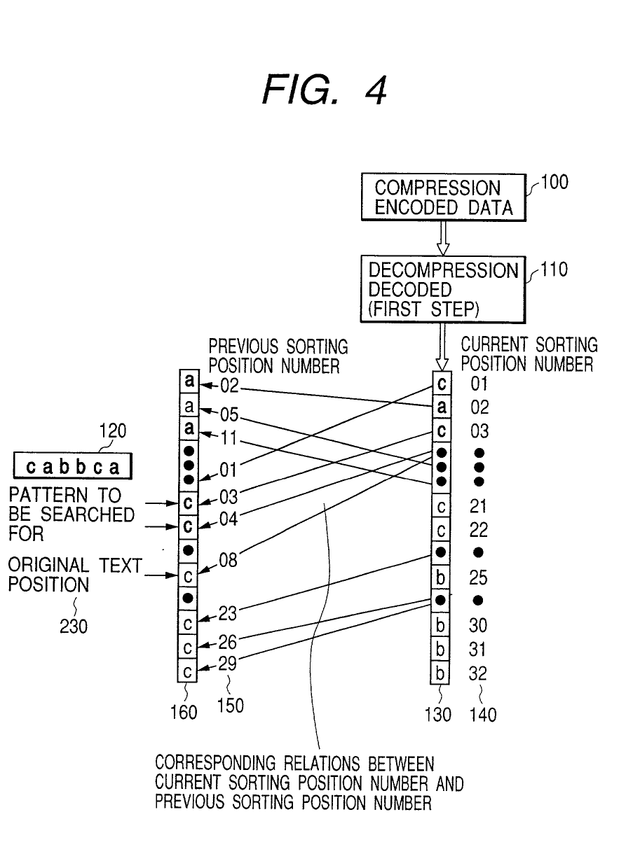

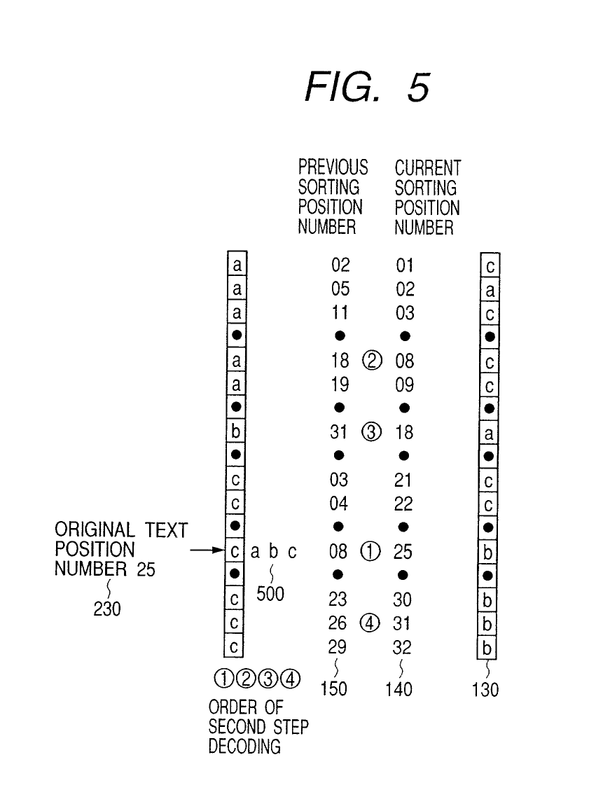

Next, the procedure of decoding and decompressing the compressed and encoded data in accordance with the above steps will be described in greater details with reference to FIG. 4 and FIG. 5.

FIG. 4 is a schematic block diagram of decompression and decoding process by the block sorting compression encoding method.

FIG. 5 is a schematic block diagram of decompression and decoding process of the block sorting compression encoding method by means of specific data.

Prior to specifically describing the practical procedure, the current sorting position number and the previous sorting position number shown in FIG. 3 will be described. The current sorting position number and the previous sorting position number carry the indispensable idea for understanding the algorithm used in the block sorting compression encoding method.

The current sorting position number is the position itself in the array 220 sorted by lexicographic order of the cyclic shift row.

The previous sorting position number is the position number which, when sorting the last row 130 of BWT so as to mate with the first row in the array, indicates in which sorting position number the sorted character was positioned before sorting.

More specifically, the last row 130 of BWT may be as follows:

“caccacccccaabbaaaaabcccbbcbacbbb”

By sorting this string, a character “a” will be the top. This character “a” was in the second position before sorting, so that the previous sorting position number of this character will be “02”. The next character will also be “a”. The next character “a” may be found at fifth in the last row 130 of BWT, so that the previous sorting position number of the character will be “05”.

In a similar manner, character “a” will be sorted at the top several times. The previous sorting position number when the character “b” is at the top for the first time will be “13”, and the previous sorting position number when the character “c” is at the top for the first time will be “01”. In such a manner, the sorted row 130 can be obtained. The principle of this correspondence can be shown in FIG. 4.

Now a rule on the symbols can be established. A pair of current sorting position number 140 and previous sorting position number 150 will be referred to as “(current sorting position number, previous sorting position number) herein after. For example, when “a” is at the top for the first time the number will be “(01, 02)”, when “b” is at the top for the first time the number will be “(11, 13)”, and when “c” is at the top for the first time the number will be “(20, 01)”.

The algorithm for decompressing and decoding the data compressed and encoded in accordance with the above steps will be as follows:

[Decompression Step 1]

The position number 230 of the original text encoded in the compression step 3 and the last row 130 of BWT will be decompressed and decoded. This step will be provisory referred to as first decompression and decoding step. This first decompression and decoding step is based on the algorithm used to encode and compress in the compression step 3.

By applying the first decompression and decoding step, the position number 230 of the original text string, “25” and the last row 130 of BWT, “caccacccccaabbaaaaabcccbbcbacbbb” will be presumably obtained.

[Decompression Step 2]

The last row 130 of BWT obtained in the previous decompression step 1 will be sorted with the lexicographic order. At this point the pairs of such (current sorting position number, previous sorting position number) as those obtained in the above step will also be stored.

In this example, as shown in FIG. 3, pairs including (01, 02), (02, 05), (03, 11), . . . , (32, 29) can be obtained.

[Decompression Step 3]

The original text 200 will be restored based on the position number 230 of the original text, the last row 130 of BWT, the sorted row 160 and pairs of (current sorting position number, previous sorting position number). This is the second step of decompression and decoding.

In this example, the step will be as follows:

At first, since the position number 230 of the original text is “25”, by referring to 25th character in the sorted row 160 (the topmost row shown in FIG. 3), the first character “c” will be decoded. It is obvious at the step that the character “c” was at eighth before sorting, by looking up the pair (25, 08) [see FIG. 5, (1)]. Then, the eighth in the sorted row 160 will be “a”. As the array is composed of cyclic shift rows, the character “a” in question is to be next place of the first character “c”. Therefore, the second character “a” will be decoded [see FIG. 5 (2)].

In a similar manner, since the 18th in the sorted row 160 is “b” by looking up the pair (08, 18), the third character will be decoded as “b”.

In the position number 230 of the original text 200, by following a chain from “25” to (25, 08), then to (08, 18), then to (18, 31), and to (31, 26), and so on, the characters in the original text 200 will be obtained sequentially by decoding as “cabc . . . ”.

The block sorting compression encoding method as can be appreciated from the above description makes use of the nature of cyclic shift rows cleverly to compress and decompress the string.

[Fundamental of searching block sorting compressed encoded data]

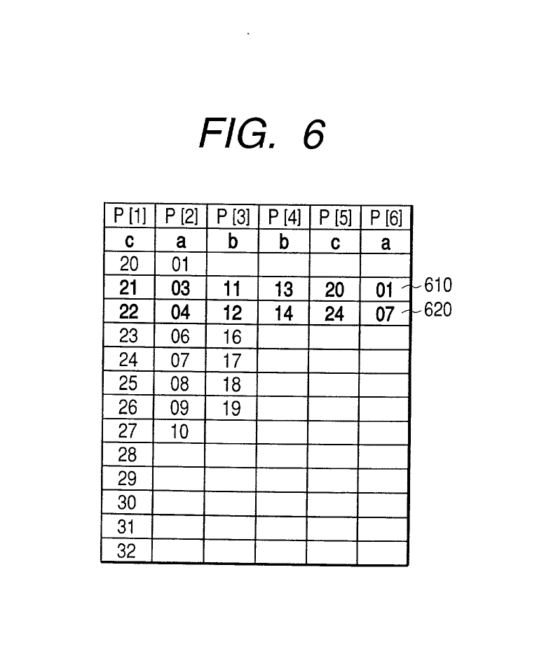

Now the fundamental principle of searching method for searching a specific pattern in the compressed data encoded by the block sorting compression encoding method (referred to as block sort compressed data, herein below) will be described in greater details with reference to FIG. 6.

FIG. 6 is a schematic block diagram of searching process of a method for searching compressed encoded data by the block sorting compression encoding method in accordance with the present invention;

In this embodiment, a character string “cabbca” will be used as the searching pattern 120. This pattern can be found in two places in the original text 200.

Now assuming a symbol defining the ith character in the searching pattern as P[i] will be used in the following description. In this example, as shown in FIG. 6, P[1]=“c”, P[2]=“a”, and so on.

The algorithm will find where in the sorted row 160 (first row) will be the first character P[1] of the search pattern 120. Since the sorted row 160 is sorted in the lexicographic order, it will be sufficient to find the number of appearances consecutive after the first appearance of the character. Therefore, the searching will be performed very easily. In comparison, when searching directly from the original text 200, the search must begin from the first character and match one by one sequentially, therefore the search must be iteratively repeated to the times equal to the character length of the original text 200. Those skilled in the art can be appreciated that the searching method in accordance with the present invention, which will find the pattern within the sorted rows and not rely on the original text, when compared to the direct search, is highly effective.

In the table shown in FIG. 6, there are shown numbers 20 to 32 beneath P[1]=“c”. These numbers are the sorting position numbers of the sorted row 160. Indeed one can confirm that these numbers 20 to 32 correspond to ‘c’ in FIG. 3.

Next, P[2]=“a” will be searched.

The search will be performed by determining the paired current sorting position number from the sorting position number found in respective P[1]. More specifically, the previous sorting position number “01” will be determined from the current sorting position number “20”, then the decoding principle of the block sorting compression encoding method will be used to restore “a”, and it can be found that the second character matches also. By investigating the pattern having “a” at the second character, as can be appreciated from the second row of the table shown in FIG. 6, the pairs (current sorting position number, previous sorting position number) may be (20, 01), (21, 03), (22, 04), (23, 06), (24, 07), (25, 08), (26, 09), and (27, 10). In the following sorting position number “28” the previous sorting position number is “18”, and the character to be decoded will be “c”, so that the searching pattern will not match. Thereafter, the pattern matching to the searching pattern will not be found based on the theorem. This is because the array 220 is sorted in the lexicographic order.

In the similar manner, the succeeding P[3]=‘b’ will be searched. The candidates to be found from the current sorting position number of P[2] will be (03, 11), (04, 12), (06, 16), (07, 17), (08, 18), and (09, 19).

In this way, from P[1] to P[6], there are only two matches as shown in FIG. 6, i.e., the row 610 including (21, 03), (03, 11), (11, 13), (13, 20), and (20, 01); and the row 620 including (22, 04), (04, 12), (12, 14), (14, 24), and (24, 07). This indicates that there are found six characters to be searched for in this position.

In accordance with this searching method, based on the sorted row 160 by the block sorting compression encoding method and the pairs of (current sorting position number, previous sorting position number), the character can be found by sequentially searching from the top P[1]. In addition, for each branching node of searching it is sufficient to go down to the length equal to the searching pattern, allowing highly efficient search to be achieved when compared to the searching of original text 200.

[Indication of text before and after a match]

In practice, there are cases in which it is desirable to display the text strings before and after a matched area during searching a searching pattern 120 in the original text 200.

In such a case, in accordance with the searching method of data compressed and encoded by the block sorting compression encoding method in accordance with the present invention, a similar procedure to the searching may be used to decompress and decode the text string before and after the match to display.

For instance, in the above-cited example, assuming that it is desirable to display the text string before the fragment in the row 610 shown in FIG. 6. By determining the current sorting position number when the previous sorting position number is “21”, then the character preceding to P[1] may be identified. More specifically, it is sufficient to find “x” in the expression (current sorting position number, previous sorting position number)=(x, 21). In this case, “x” is 28, the 28th character in the sorted row 160 will be “c” so that the character to be found will be “c”. The character preceding to this may also be found from (x, 28), then x will be 10, so that the target character will be “a”.

On the contrary, when it is desirable to display the character after the fragment in the row 610 shown in FIG. 6, then it can be done by determining the previous sorting position number for the current sorting position number “01” from the very last pair (20, 01). More specifically, the previous sorting position number can be determined by determining “y” in (current sorting position number, previous sorting position number)=(01, y). Here “y” may be 02, and the second character in the sorted row 160 can be determined to “a”. Therefore the character immediately after P[6] will be “a”. In a similar manner, when determining “y” in (02, y), “y” may be 05 and the next character can be determined to be “a”.

The characters before and after a given fragment in the original text 200 equal to the search pattern 120 can be determined by following the chain of (current sorting position number, previous sorting position number) to decode without difficulty to display on an output device such as a CRT or to print through a printer.

[Application to the ambiguous search]

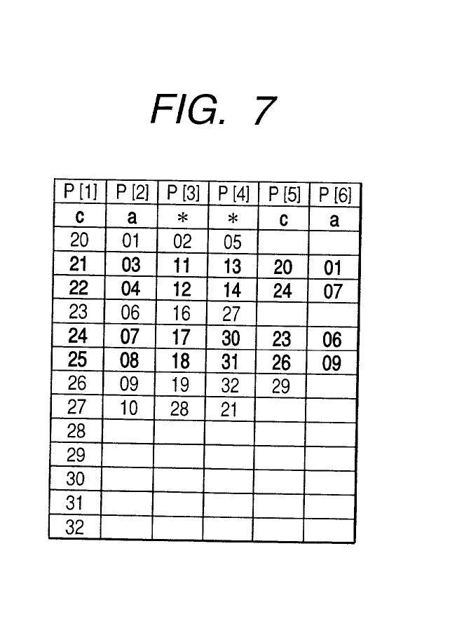

Now referring to FIG. 7, the application of the searching method of block sorting compressed data in accordance with the present invention to the ambiguous search will be described in greater details.

FIG. 7 is a schematic block diagram of ambiguous searching process of a method for searching compressed encoded data by the block sorting compression encoding method in accordance with the present invention.

In a text string search a so-called ambiguous search is often desirable for searching the block sorting compressed and encoded data. The ambiguous search is a type of search, for example, which intends to find a pattern by specifying part of a word, with any character(s) for the rest. For example, an asterisk (*) may indicate a symbol which do not care, or in other words a wild card, which may match to any occurrence of character(s). When using an ‘*’ symbol in the search pattern, this may match to any character.

In this example, for example, if a pattern “ca**ac” is specified for an ambiguous search, then P[3]=P[4]=“*”, and the rest is similar to the example above.

In this case, by the searching method in accordance with the present invention as have been described above, a matching position for P[1]P[2]=“ca” will be searched. There will be eight matched positions as shown in FIG. 7, including (20, 01), (21, 03), (22, 04), (23, 06), (24, 07), (25, 08), (26, 09) and (27, 10), when expressing in (current sorting position number, previous sorting position number).

For P[3]P[4]=“**”, any two characters may match thereto. Thus, the pattern may follow the chain of (current sorting position number, previous sorting position number) pairs. In this process, the number of candidates will not decrease. Then among these candidates, only those which may match to the following pattern P[5]P[6]=“ca” will be pursued so as to definitively narrow the candidates. More specifically, there will be five candidates that match at the position P[5] as shown in the figure, and those candidates will be further narrowed in the match at the position P [6]. The result of this ambiguous search will show those four positions shown in FIG. 7.

[Improvement of efficiency in the searching method of block sorting compressed and encoded data, part 1]

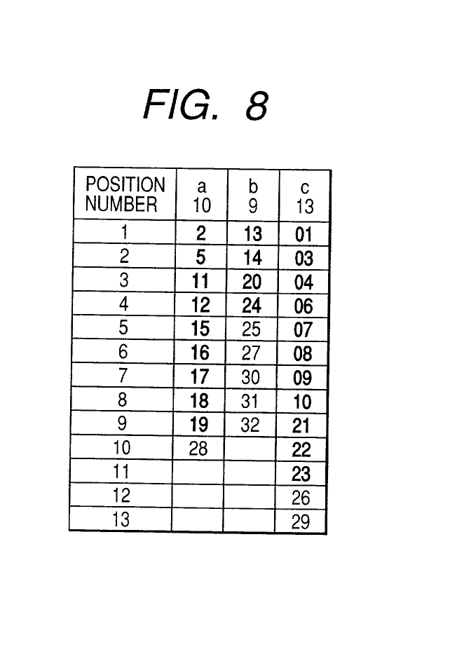

Although the principle of searching method of the block sorting compressed and encoded data in accordance with the present invention has been described above, now a typical way to improve the efficiency of the searching method in accordance with the present invention will be described with reference to FIG. 8.

FIG. 8 is a schematic block diagram of decoding and searching process in response to the number of appearances of the original text string.

In the principle of the searching method of block sorting compressed and encoded data as have been described above, the search has been described as may be performed based on the decoded and BW transformed row 130 (the last row) by decompressing and decoding the data in correspondence with the first step of the block sorting compression method.

The following searching method in accordance with the present invention may perform a search without completely and necessarily decoding the BW transformed row 130. This allows a further efficient search to be achieved.

The condition required for this search is that the encoding must be done such that the number of occurrence of the characters in the original text 200 can be retrieved. In this example, the number of “a” is 10, “b” is 9, and “c” is 13. The key to improvement of efficiency in the following searching method is that the search pattern can be matched by sequentially decoding the data, because each time the data is processed from the beginning of the BW transformed row 130 a pair of current sorting position number and previous sorting position number can be determined, if the number of occurrence of characters is known.

The procedure will be as follows. At first, the first occurrence of character in the BW transformed row 130 is “c”. This is first of “c”, and the number of occurrence of the character is known, the sorting position number of “c” will be calculated as 10+9+1, therefore (current sorting position number, previous sorting position number)=(20, 01) will be given.

In FIG. 8, previous sorting position numbers are shown for each character, in which the cell number 1 of “a” corresponds to the sorting position number 1, the cell number 1 of “b” corresponds to the sorting position number 11, and the cell number 1 of cit corresponds to the sorting position number 20.

Then next character “a” is the first occurrence of “a”, having the sorting position number of 1. In other words, (current sorting position number, previous sorting position number)=(01, 02). In a similar manner, for the third occurrence of character “c”, the sorting position number can be calculated as 10+9+2=22, and (current sorting position number, previous sorting position number)=(22, 03). This corresponds to the previous sorting position number 3 of the second occurrence of the cell of “c”. As can be appreciated, FIG. 8 indicates that each time a character “a”, “b”, or “c” appears, the current sorting position number can be determined automatically by substituting the previous sorting position number into the cell in the corresponding row.

The search pattern 120 used herein is “cabbca”.

Now assuming that the sorting process has been performed to the point of the first occurrence of character “b”. As can be easily appreciated from FIG. 8, the character “b” appears 13th from the beginning of the text string, in other words the character “b” has its previous sorting position number of 13, and its sorting position number may be 10+1=11.

To this end, among pairs of (current sorting position number, previous sorting position number), those that matches to the search pattern 120 may be sequences (21, 03) (03, 11) (11, 13) and (22, 04) (04, 12). The character string “cabb” and “cab” can be matched.

At the stage in which the sorting operation is done to the 24th character “b” in the BW transformed row 130, there are sequences (21, 03) (03, 11) (11, 13) (13, 20) (20, 01) and (22, 04) (04, 12) (12, 14) (14, 24) (24, 07), with which the string “cabbca” of the search pattern 120 can be matched.

It can be appreciated that the search pattern 120 “cabbca” will not appear in the text thereafter. This means that the previous sorting position numbers 11 through 19, indicating the character “b”, may not be substituted into “xx” in (current sorting position number, previous sorting position number)=(16, xx). This is because characters up to 24th have been already investigated and that the previous sorting position numbers 11 through 19 have been revealed to be used elsewhere. Therefore, the character “b” will not appear thereafter and further searching operation will be unnecessary.

This is an advantage of the searching method of block sorting compressed and encoded data in accordance with the present invention when compared with the searching operation by matching to ordinary plain text source, which needs to scan through the entire text up to the very last character in order to detect every occurrence of the searching pattern. However, searching through the entire text may be required in some worst cases.

[Improvement of efficiency in the searching method of block sorting compressed and encoded data, part 2]

Now another way to improve the efficiency of the searching method of block sorting compressed and encoded data in accordance with the present invention will be described herein below with reference to FIG. 1.

Now referring to FIG. 1, there is shown a schematic block diagram of searching method of block sorting compressed data in accordance with the present invention.

In the searching method of block sorting compressed and encoded data in accordance with the present invention, the matching operation is performed from the beginning of the search pattern 120. However, in case in which the occurrences of the leading character P[1] of the search pattern 120 in the original text 200 is frequent, the algorithm is required to perform repetitively first matching operation for the times equal to the number of occurrences in order to narrow the candidates. In order to prevent the occurrence of such situation, it will be more efficient to select a character that appears less frequent in the original text 200 among the characters of the search pattern 120 to perform the searching operation from the position of thus selected character to narrow the candidates at first, then to pick up backwardly the character immediately before the selected one to repeat the matching.

It is preferable to find the first occurrence of the search pattern 120 at first rather than detect the positions of plural occurrences at the same time in order to narrow the second occurrence and after quickly.

In the example of search pattern 120 “cabbca”, there are three types of characters, namely “a”, “b”, and “c”. In the original text 200, the number of occurrences of the character “b” is 9, that is the least occurrences. Therefore, the searching operation will begin with third character “b” of the search pattern 120.

As shown in FIG. 1, the forward match will examine the sequence (11, 13) (13, 20) (20, 01), while the backward search will examine the sequence (21, 03) (03, 11) and so on. As can be appreciated, selecting an arbitrary one character in the searching pattern to perform matching operation is one of characteristics of block sorting lossless compression method, which allows decoding symmetrically in both forward and backward direction by using the current sorting position numbers and the previous sorting position numbers.

[Corrected compression encoding in the block sorting lossless compression method]

Searching method based on the block sorting lossless compression and encoding method has been described above. In the above searching method, the decompression and decoding operation in the first step of the block sorting lossless compression method will be performed and then the decompression and decoding operation in the second step using the (current sorting position number, previous sorting position number) to match with the searching pattern. As a typical example of first step encoding, run length encoding using the consecutive length of character string has been described.

Now another way to perform searching the block sorting compressed and encoded data will be described, in which in the first encoding step, the (current sorting position number, previous sorting position number) will be directly encoded to perform the second encoding step and decoding step at once in order to further improve the searching efficiency of the block sorting lossless compressed and encoded data.

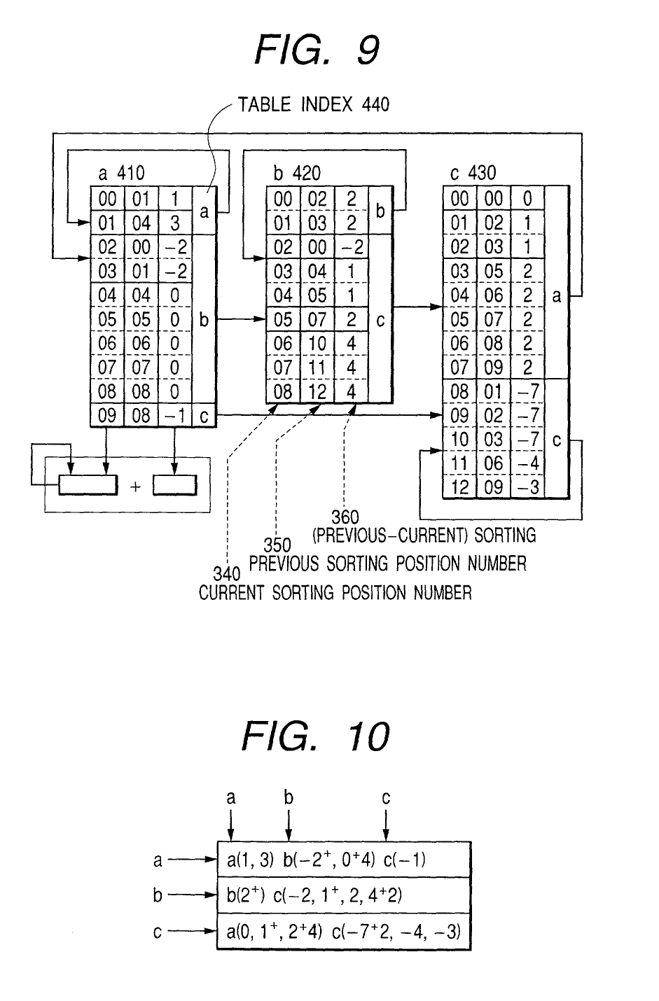

Referring to FIG. 9 and FIG. 10, the searching method will be described using the same example as cited above.

FIG. 9 is a schematic block diagram of compression encoding compensated for by the block sorting compression encoding method in accordance with the present invention.

FIG. 10 is a schematic block diagram of compressed encoded data.

The block sorting compression encoding method uses the (current sorting position number, previous sorting position number) to perform decompression and decoding in the second step. The fundamental concept of the inventive searching method is such that by directly encoding the (current sorting position number, previous sorting position number) the matching operation in the decoding process can be omitted.

In FIG. 9, the current sorting position numbers 340 and the previous sorting position numbers 350 are listed for the table “a” 410, table “b” 420 and table “c” 430.

Both current sorting position numbers 340 and previous sorting position numbers 350 begin with zero. This is a technical work-around for decreasing the storage capacity required at the time of encoding as much as possible.

The BW transformed row 160 tends to have the same characters successively, a sequence of consecutive numbers may be expected in the previous sorting position numbers. Thus, it is anticipated that the previous sorting position number 350 expressed in the relative position of those tables, may result in a higher compression ratio. In this situation, the previous sorting position numbers 350 can be expressed as the relative numbers of those tables together with the table index 440.

The current sorting position number 340 in the first entry of the table “a” 410 is 00, the previous sorting position number 350 is 01, and the table index 440 is “a”. This corresponds to (current sorting position number, previous sorting position number) of (01, 02) as shown in FIG. 3. In addition, the current sorting position number 340 in the third entry of the table “a” 410 is 02, the previous sorting position number 350 is 00, and the table index 440 is “b”. As shown in FIG. 8, the initial position in the table “b” points to 11th so that the (current sorting position number, previous sorting position number) of FIG. 3 will be (03, 11).

When encoding this, the difference between the previous sorting position number 350 and the current sorting position number 340 will be first determined so as to enable relative encoding and then to encode together with the table index so as to allow decoding together.

FIG. 10 shows thus encoded data in such a manner that the encoding scheme is well expressed. In this figure, the table index and the relative position are encoded and the notation is devised when the same character appears in succession. The notation i+j indicates that “i” appears in succession “j” times.

In FIG. 10, a (1, 3) indicates that the table index is “a”, the difference 360 between the current sorting position number 340 and the previous sorting position number 350 is 1 and 3. The next entry, b (−2+, 0+4) indicates that the table index is “b”, and the differences 360 are −2, −2 and so on and four zero in succession.

[Algorithm of the searching method of block sorting lossless compressed and encoded data]

Finally, the algorithm of the searching method of block sorting lossless compressed and encoded data will be summarized on the basis of above explanation with reference to FIG. 1.

FIG. 1 is a schematic block diagram of searching method of block sorting compressed data in accordance with the present invention.

Now it is assumed that data that the original text 200 is compressed and encoded by means of the block sorting lossless compression method is stored on a recording medium.

In addition, a search pattern 120 to be searched is already specified.

The searching method in accordance with the present invention is, as have been described above, such that the compressed and encoded data 100 will be decompressed and decoded while at the same time allowing the matching operation with the search pattern 120.

The search may begin with an arbitrary character. However it will be efficient to start with “b” in this example, character that is the least occurrence in the original text. When decoding, the partial string of text that matches with the searching pattern will be narrowed while following catenatively and sequentially the pairs of (current sorting position number 140, previous sorting position number 150) to decode in both forward and backward direction. The search may be performed sequentially without decoding all of the compressed and encoded data 100 to the original text 200, as have been described above, if the number of occurrence of characters is recorded or the pairs of (current sorting position number 140, previous sorting position number 150) are encoded in the first encoding step.

When a search hits and the appropriate occurrence is found, then the characters before and after the matched section may be displayed to the user if necessary.

[Effect of the Invention]

The searching method of block sorting lossless compressed and encoded data in accordance with the present invention allows the character string pattern to be searched from the top of the target text data at the same time for every occurrences of the searching pattern if the pattern may appear several times in the target text. In addition, when the match is completed for the length of the searching pattern, all matching positions will be detected. The searching method in accordance with the present invention is therefore a high efficiency compression method of data, which allows to efficiently speed up searching. The searching method in accordance with the present invention may decode directly the character strings in the text before and after the searching pattern so that the character strings forward and backward of the detected searching position may be displayed on the display screen at the same time, conveniently applicable in a variety of fields. Direct encoding of pairs of current sorting position numbers and previous sorting position numbers used in the block sorting lossless compression and encoding method may be useful in the searching method in accordance with the present invention.

In accordance with the present invention, by exploiting the nature of block sorting lossless compression and encoding method for the data compressed and encoded by the block sorting compression method, a searching method of the block sorting compressed and encoded data is provided which allows high speed search by decoding and examining only the necessary data portion without needs of decoding all of encoded data.

The present invention also provides an encoding method of block sorting lossless compression method suitable for the searching operation.

What is claimed is:

1. A searching method of block sorting lossless compressed and encoded data, with data encoded by the block sorting compression method being first data string, and data lexicographically sorted of said first data string being second data string, comprising the following steps of:
(1) determining the pair of current sorting position number and previous sorting position number when sorting said first data string to said second data string;
(2) decoding the original data string based on said pair of current sorting position number and previous sorting position number determined in said step (1); and
(3) matching data string decoded in said step (2) with a searching data;
characterized by
entering said first data string and searching data string;
performing said step (2) after said step (1); and
performing said step (3) using data decoded sequentially to examine whether or not the original data string includes the searching data string.

2. A searching method of block sorting lossless compressed and encoded data, according to claim 1, wherein:
data encoded by the block sorting compression encoding method is encoded such that the number of occurrences of data elements is explicit;
search operation is performed by decoding only necessary data required for matching with the searching data string in said step (3) by determining said pair of current sorting position number and previous sorting position number, based on the occurrence of said data element, without decoding all of the original data string in said step (2).

3. An encoding method of block sorting lossless compression and encoding method, comprising:
when encoding sampled data string after a cyclic shift, directly encoding pairs of current sorting position number and previous sorting position number used for transforming thus sampled data string into data string sorted in the lexicographic order.

4. A searching method of block sorting compressed and encoded data according to claim 1, wherein:
when matching, in said step (3), said searching data string with the original data string, the matching operation is started with the data element of the least occurrence in the elements of the original data string.

5. A searching method of block sorting compressed and encoded data according to claim 1, wherein:
data elements in said searching data string are not uniquely specified;
when matching, in said step (3), said searching data string with the original data string, a search operation is performed so as to match thus specified expression with a plurality of elements.

6. A searching method of block sorting compressed and encoded data according to claim 1, wherein:
in said step (3), data string before and after the position including said searched and retrieved data string in said original data string is also decoded to display.
